(19) United States
(12) Patent Application Publication
(10) Pub. No.: US 2014/0102749 A1
(43) Pub. Date: Apr. 17, 2014

(54) Electric Submersible Pump Cables for Harsh Environments

(71) Applicant: Joseph Varkey, Sugar Land, TX (US)

(72) Inventor: Joseph Varkey, Sugar Land, TX (US)

(21) Appl. No.: 14/053,602

(22) Filed: Oct. 15, 2013

Related U.S. Application Data
(60) Provisional application No. 61/714,219, filed on Oct. 15, 2012.

(51) Int. Cl. H01B 7/04; H01B 19/00; H01B 9/00

(52) U.S. Cl. CPC H01B 7/046; H01B 9/00; H01B 19/00
USPC 174/102 R; 29/887

(57) ABSTRACT

A cable for supplying power to an electric submersible pump (ESP) includes a helically disposed electrical conductor, at least one polymer layer extruded to embed the helically disposed electrical conductor, and a seam-welded metallic tube drawn over the hard polymer layer, all providing resistance to corrosive chemicals at high downhole pressures and temperatures. In an implementation, the helical disposition of cable components, added cushioning polymers and geometry, and a non-leaded metallic tube compensate for stress and differential thermal expansion to keep the cable protected from intrusion of corrosive chemicals. An example method of manufacture includes extruding a polymer layer to embed the helically disposed electrical conductor, seam-welding a metal strip to form a metallic tube around the polymer layer, and drawing the metallic tube down to fit tightly around the polymer layer.

### RELATED APPLICATIONS

This patent application claims the benefit of priority to U.S. Provisional Patent Application No. 61/714,219 filed Oct. 15, 2012 entitled, “ESP Cables for Harsh Environments,” incorporated herein by reference in its entirety.

### BACKGROUND

Oil wells rely on natural gas pressure to propel crude oil to the surface. In mature oilfields or wells with heavy oil, gas pressure may diminish and be insufficient for bringing the oil to the surface. Electrical submersible pumps (ESPs) attach to the bottom of a production string and pump oil from the bottom of the well. Power to ESPs is provided by relatively permanent cables designed for long-term deployment. But the downhole environment can contain harsh chemicals, such as hydrogen sulfide (H₂S) and carbon dioxide (CO₂) at high pressures and temperatures. Given the long-term deployment of the cables, the cables often suffer chemical and thermal damage. A conventional technique extrudes a layer of lead metal over the conductors, but the weight of lead greatly increases the overall weight (long cables may weight several tons). Also, lead metal is inflexible and does not bend easily over drums and sheaves. When bent to smaller radii (over sheaves) a lead coating is brittle and prone to small, radial cracks which allow fluids and gases to intrude and damage the conductors.

### SUMMARY

An example cable for supplying power to an electric submersible pump (ESP) includes a helically disposed electrical conductor, at least one polymer layer embedding the electrical conductor, and a seam-welded metallic tube drawn over the polymer layer, all providing resistance to corrosive chemicals at high downhole pressures and temperatures. The helical disposition of the cable, cushioning polymers, and non-leaded metallic tube can compensate for stress and differential thermal expansion to keep the example cable protected from intrusion of the corrosive chemicals in the event of small holes and cracks. An example method of manufacture includes extruding a polymer layer to embed a helically disposed electrical conductor, seam-welding a metal strip to form a metallic tube around the polymer layer, and drawing the metallic tube down to fit tightly around the polymer layer. This summary section is not intended to give a full description of electric submersible pump cables for harsh environments. A detailed description with example embodiments follows.

### BRIEF DESCRIPTION OF THE DRAWINGS

FIG. 1 is a diagram of example helically disposed conductor members.

FIG. 2 is a diagram of an example seam-welded metallic tube drawn over hard polymer insulation and conductors, and method of manufacture.

FIG. 3 is a diagram of an example ESP cable with hard polymer and soft polymer layers underlying a seam-welded metallic tube, and method of manufacture.

FIG. 4 is a diagram of an example ESP cable with a serrated hard polymer surface to anchor a soft polymer layer, and method of manufacture.

FIG. 5 is a diagram of example ESP cable with a layer of synthetic yarn to compensate for thermal expansion, and method of manufacture.

FIG. 6 is a diagram of an example synthetic yarn coated with a soft polymer for use in an example ESP cable.

FIG. 7 is a diagram of example ESP cable with a layer of synthetic yard embedded in soft polymer, and method of manufacture.

FIG. 8 is a diagram of example ESP cable with a serrated hard polymer layer to cushion and compensate for thermal expansion, and method of manufacture.

FIG. 9 is a diagram of example ESP cable with a closed-cell foamed polymer layer.

FIG. 10 is a diagram of example ESP cable with a smooth outer jacket having an armor of strength members and corrosion-resistant polymer.

FIG. 11 is a flow diagram of an example method of constructing an electric submersible pump cable for harsh environments.

### DETAILED DESCRIPTION

Overview

This disclosure describes electric submersible pump (ESP) cables for harsh environments. ESP's for the oil and gas industry endure a harsh environment, including terrestrial and subsea well depths down to 12,000 feet, high pressures of up to 5,000 pounds per square inch, high temperatures up to 150 degree Celsius that may fluctuate wildly, and corrosive fluids and gases at high temperatures and pressures, such as pressurized, high temperature hydrogen sulfide (H₂S) and carbon dioxide (CO₂). Moreover, cables supplying power to an ESP, while resisting the harsh ambient environment, must reliably carry high amperage at high voltage over a distance that may be several miles deep, to power pump motors that may generate 1000 horsepower or more.

Example cables described herein are capable of withstanding long-term exposure to heat, pressure, gases, fluids, and electrical power encountered in the downhole environment. The example cables compensate for different thermal expansion coefficients of cable components by using a helical configuration for the conductors, layers, and armors, and by employing geometry, cushioning schemes, and strategic polymers that provide space for expansion, when needed, within metallic tubular armors. The strategically-placed polymers are formulated to swell in the presence of well fluids, providing resistance to the infiltration and migration of downhole fluids and gases.

Example Cables

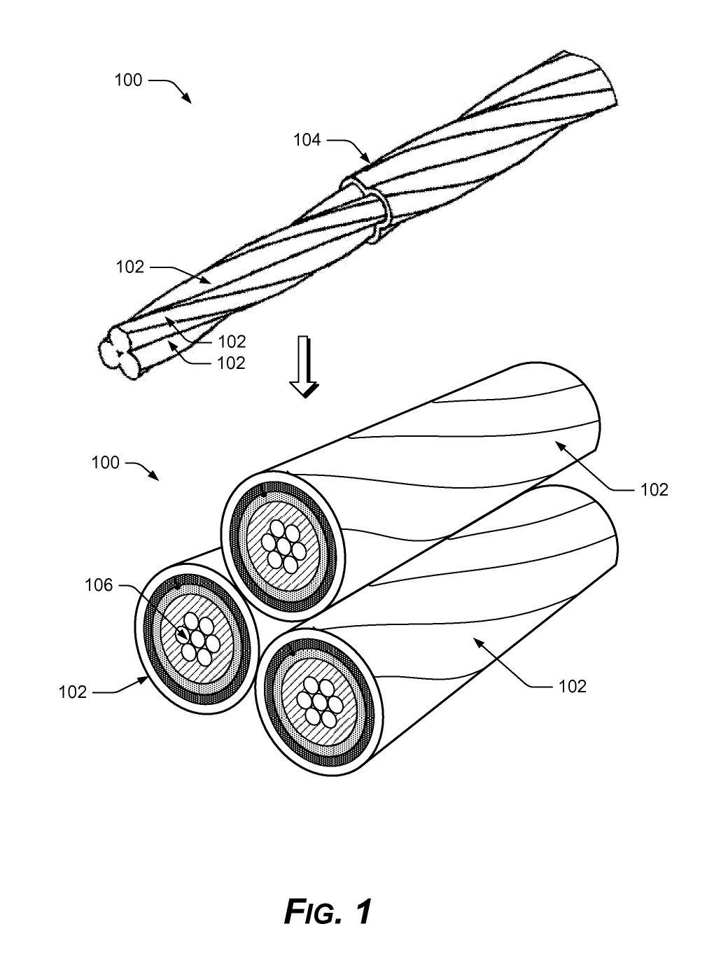

FIG. 1 shows an example cable 100 with three separate conductor members 102. The three separate conductor members 102 may be surrounded or further encased in one or more outer layers 104, such as polymers or metallic armor. Each conductor member 102 includes a solid metallic conductor 106 (wire, braided wire, stranded wire, conduit, and so forth) to carry electrical power, embedded in an electrical insulation. The example cable 100 may have a helical configuration of its metallic conductors 106, of its insulated conductor members 102, and of its outer layers 104. The helical configuration may consist of an open helix configuration around a cable axis, helical braiding or coiling, or a slight twist manufactured into one or more of the components.

The helical configuration of one or more cable components provides some tolerance for thermal expansion and contraction of the components, which may each have different thermal expansion coefficients. That is, the geometry of the helical configuration can provide some cross-sectional space for thermal expansion of a cable component, and can also provide some longitudinal play. When the cable 100 gets hot, the helical geometry of the cable 100 may untwist slightly to accommodate longitudinal thermal expansion of a component. When the cable 100 cools, the twist of the helix may tighten to accommodate thermal contraction of a cable component.

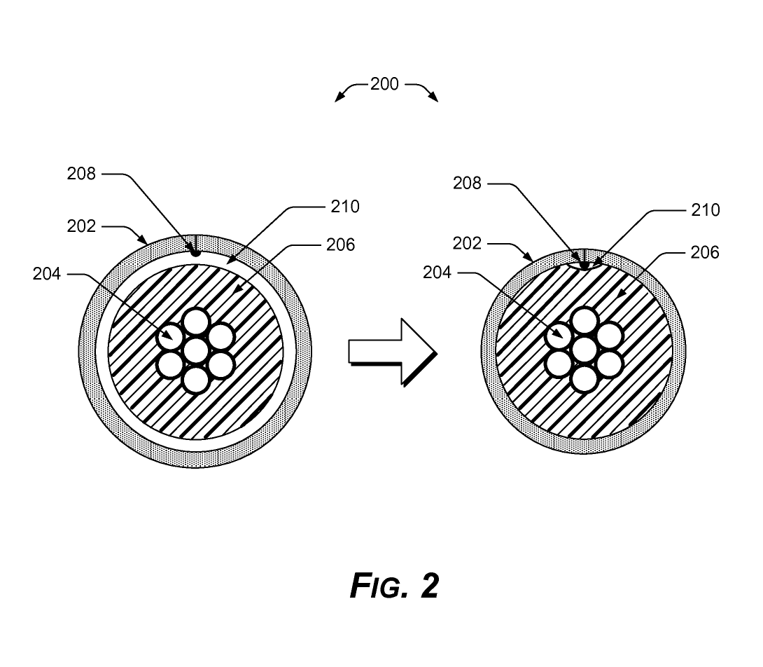

FIG. 2 shows an example cable 200 with a seam-welded steel tube 202 drawn over the insulated conductor members 204. The conductor members 204 are protected by seam-welding the metallic tube 202 over the conductor members 204 and then drawing the tubing 202 down until it fits tightly over the hard polymer layer 206 insulating each conductor member 204. A bead 208 from the seam-welding process may create a longitudinal ridge inside the tube. The steel tube 202 provides good protection, although when the tubing 202 is drawn down over the hard polymer 206, a gap 210 is created between the polymer 206 and the tube 202. Pressurized gases or fluids intruding into the interior can travel along this gap 210 and can cause damage to the conductor 204 or can flood the termination at an end of the cable 200.

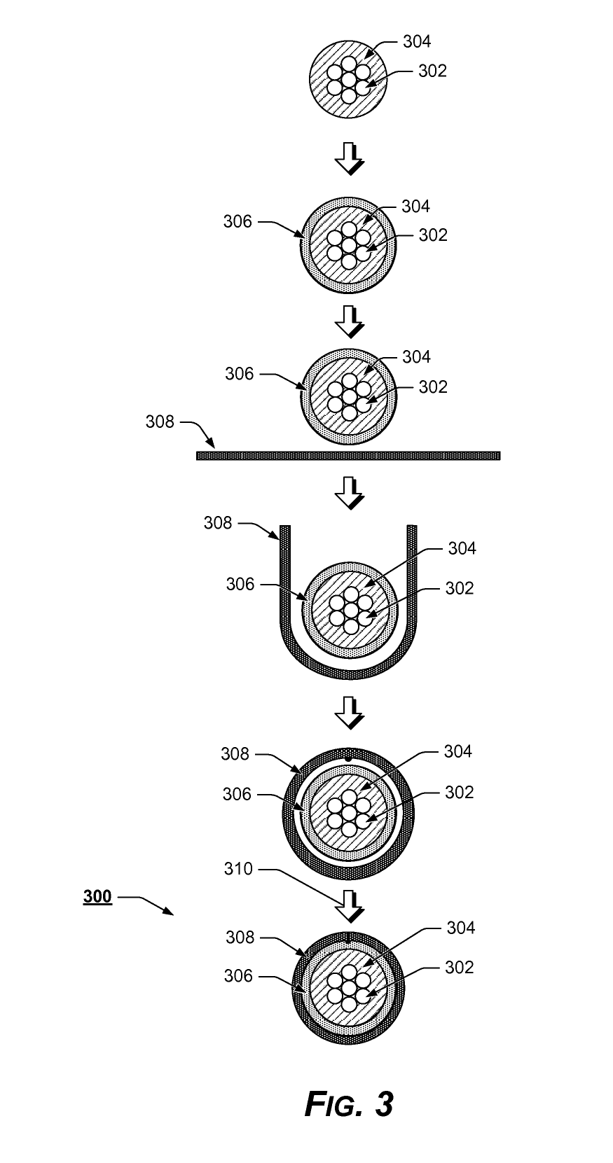

FIG. 3 shows an example manufacturing process to construct another example metallic tube-encased cable 300 with polymer-insulated conductor members 302. The example cable 300 has a stranded or a solid metallic conductor 302 encased in a suitable insulation 304. A layer of soft polymer 306 is added on top of the insulation 304. A metallic tube 308 is seam-welded over the outer soft polymer layer 306 and then the metallic tube 308 is drawn down 310 to fit tightly over the soft polymer 306. The soft polymer 306 may be bonded to the insulation 304.

In an implementation, the insulation 304 is a layer of hard polymer 304 extruded over the solid-core or stranded metallic conductor 302 to provide both electrical insulation and physical protection. An outer layer of soft polymer 306 is then extruded over the hard polymer layer 304. Then, a strip of suitable metal is used to create the metallic tube 308 over the conductor member 302. The metallic strip 308 is passed through a series of shaping dies as needed to create a metallic tube 308 over the conductor 302 and polymer layers. When the metal tube 308 is formed, the edges are seam welded to complete the tube 308. The metallic tube 308 is drawn down to fit tightly over the outer soft layer 306 of the conductor 302. The soft polymer 306 conforms against the inside of the metallic tube 308 and seam-welding bead, if any, to fill any interstitial spaces that may be present.

The hard polymer 304 used as electrical insulation in an individual conductor member such as cable 300, for example, may be made of crystallized poly(ether ether ketone—PEEK), insulation-grade ethylene-propylene diene monomer (EPDM), polypropylene, a perfluoroalkoxy (PFA) fluoropolymer, a fluorinated ethylene propylene (FEP) polymer, or another suitable polymer based on physical, electrical and bonding characteristics.

As an outer jacket over the insulated copper conductors 302, a soft polymer 306 such as ethylene-propylene diene monomer (EPDM), amorphous PEEK, FEP, PFA, TEFZEL modified ethylene-tetrafluoroethylene (ETFE) fluoroplastic, polyvinylidene fluoride (PVDF), or other suitable soft polymer 306 may be used to allow the soft jacket to deform and to fill the space between the weld bead and the metallic shell (TEFZEL: DuPont Corporation, Wilmington, Del.). Such soft polymer 306 may be extruded over the bundled conductors to fill the interstices between the conductors. The soft polymer 306 may be bondable to the hard polymer 304 below. The soft polymer 306 used has a very high resistance to harsh chemicals, such as hydrogen sulfide and carbon dioxide to protect the insulation 304 in case there is a pinhole or other breach in the metallic cladding 308.

The metallic seam-welded tube 308 may be made of an alloy that can withstand harsh downhole environmental factors (e.g., hydrogen sulfide or carbon dioxide at high temperatures and pressures) such as inconel, HC 265, MP 35 or other suitable alloy; or the metallic tube 308 may be constructed of a suitable steel in a chemically resistant plating (nickel, molybdenum or other suitable combination of alloy materials).

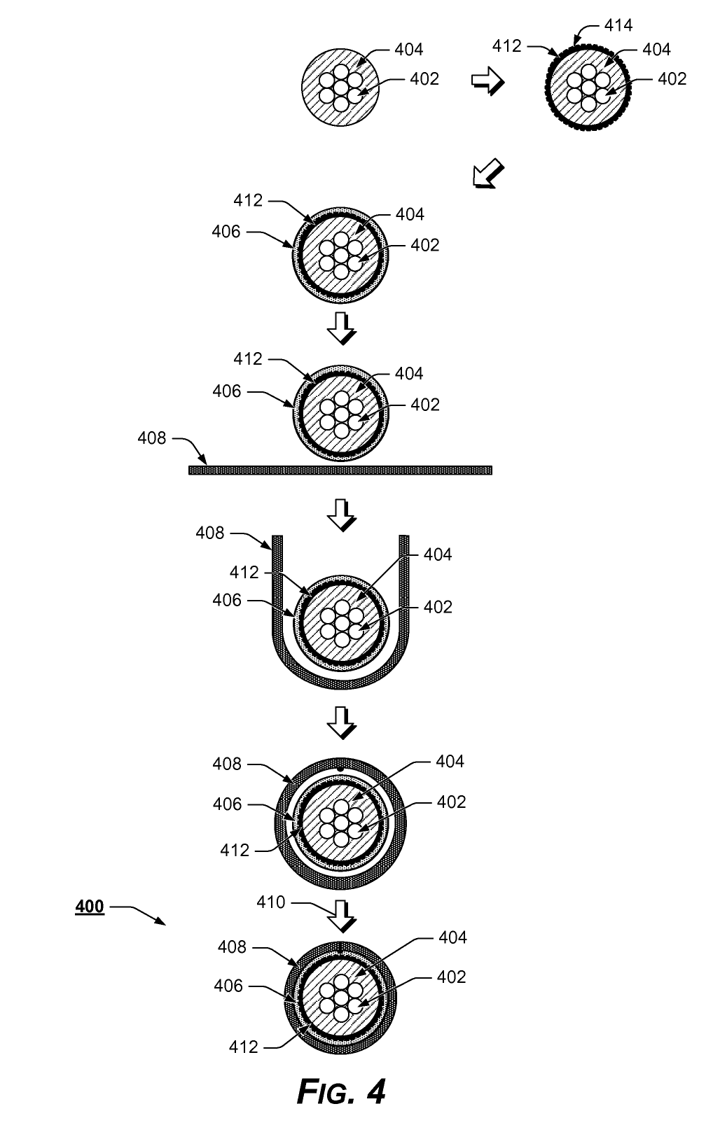

FIG. 4 shows an example metallic tube-encased cable 400 that has conductors 402, a hard polymer layer 404 with serrated surface, a soft outer polymer layer 406, and metal cladding 408. The example cable 400 is similar to that shown in FIG. 3, except the example cable 400 has a second hard polymer layer 412 with a serrated surface 414, applied over the first hard polymer layer 404. The serrated surface 414 allows the soft outer polymer 406 to grip more effectively to the hard polymer layer 404 beneath and holds the soft polymer layer 406 in place.

FIG. 4 depicts an example manufacturing process for making the example cable 400 with serrated surface 414 for securing the soft polymer layer 406. A first layer of hard polymer 404 is extruded over a single or stranded metallic conductor 402 to provide electrical insulation and physical protection. A second layer of hard polymer 412 with a serrated outer surface 414 is extruded over the first hard polymer layer 404. In an implementation, the second hard polymer layer 412 may be the same material as the first insulation polymer layer 404 and can be a single continuous matrix that can be extruded in one step over the metallic conductor 402. Then, an outer layer of soft polymer 406 is extruded over the second hard polymer layer 412. The soft polymer layer 406 may be bonded to the serrated surface 414 of the hard polymer 412 below. A strip of suitable metal is used to create a metallic tube 408 over the conductor 402. The metallic strip 408 is passed through a series of shaping dies as needed to create a metal tube 408 over the conductor 402. When the metal tube 408 is formed, the edges are seam welded to complete the tube 408. Then the metallic tube 408 is drawn down to fit tightly over the outer soft polymer layer 412 of the conductor 402. The soft polymer layer 412 conforms against the inside of the metallic tube 408 to fill any interstitial spaces. The soft polymer material 412 may be a fluoropolymer, such as PFA; may be FEP, TEFZEL, polyvinylidene fluoride (PVDF) or similar polymers that have high resistance to harsh chemicals, such as hydrogen sulfide and carbon dioxide. The soft polymer material 412 protects the insulation 404 in case there is a pinhole in the metallic cladding 408.

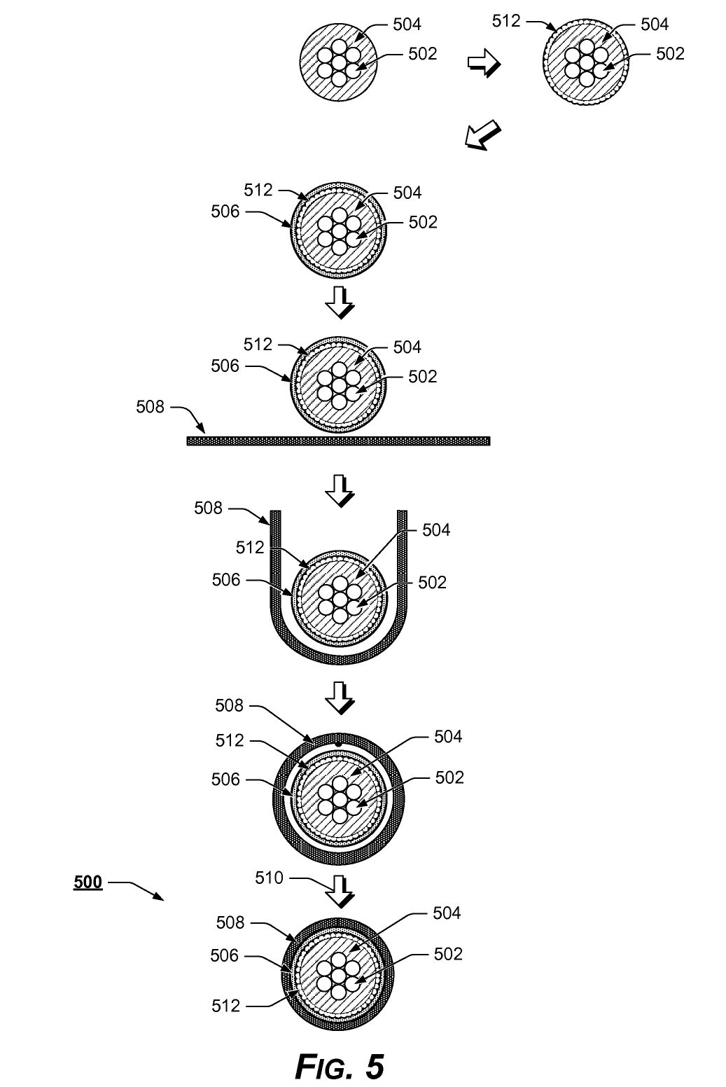

FIG. 5 shows an example cable 500 having metallic-tube 508 encased conductors 502 with thermal expansion compensated for by a served yarn or an extruded yarn layer 512.

In an implementation, the example cable 500 has a stranded or solid metallic conductor 502 encased in a suitable insulation polymer 504. A thin synthetic yarn layer 512 made of glass, KEVLAR, polyamide, polyester, acrylic, polytetrafluoroethylene (PTFE), or other synthetic fiber is served above the insulation 504 (KEVLAR: DuPont Corporation, Wilmington, Del.). Over the served synthetic yarns 512 a layer of soft polymer 506 is added on top. A metallic tube 508 is seam welded over the outer soft polymer layer 506 and then the metallic tube 508 is drawn down to fit tightly over the soft polymer 506. In operation, the air in the served synthetic yarn layer 512 compresses to compensate for the pressure induced by differential thermal expansions of different components. A braid in the yarn layer 512 is not used because a braid creates more pressure on the insulation 504 due to the crossover of thread or fiber at the braid points.

FIG. 5 also depicts an example manufacturing process for making an example cable 500 with a yarn layer 512. A layer of hard polymer 504 is extruded over a single or stranded metallic conductor 502 to provide electrical insulation and physical protection. A thin layer of served synthetic yarn 512 is applied over the insulation layer 504. Then, an outer layer of soft polymer 506 is extruded over the served synthetic yarn 512. A strip of suitable metal is used to create a metallic tube 508 over the underlying layers. The metallic strip 508 is passed through a series of shaping dies as needed to create the metal tube 508 over the underlying conductor 502 and other layers. When the metal tube 508 is being formed, the edges are seam welded to complete the metal tube 508.

The metallic tube 508 is then drawn down to fit tightly over the outer soft layer 506 of the inner conductor 502. The soft polymer 506 conforms against the inside of the metallic tube 508 to fill any interstitial spaces. The soft polymer material 506 may be made out of fluoropolymer, such as PFA, FEP, TEFZEL, polyvinylidene fluoride (PVDF) or similar polymers that have very high resistance to harsh chemicals, such as hydrogen sulfide or carbon dioxide. The soft polymer 506 protects the yarn layer 512 and insulation layer 504 in case there is a pinhole in the metallic cladding 508.

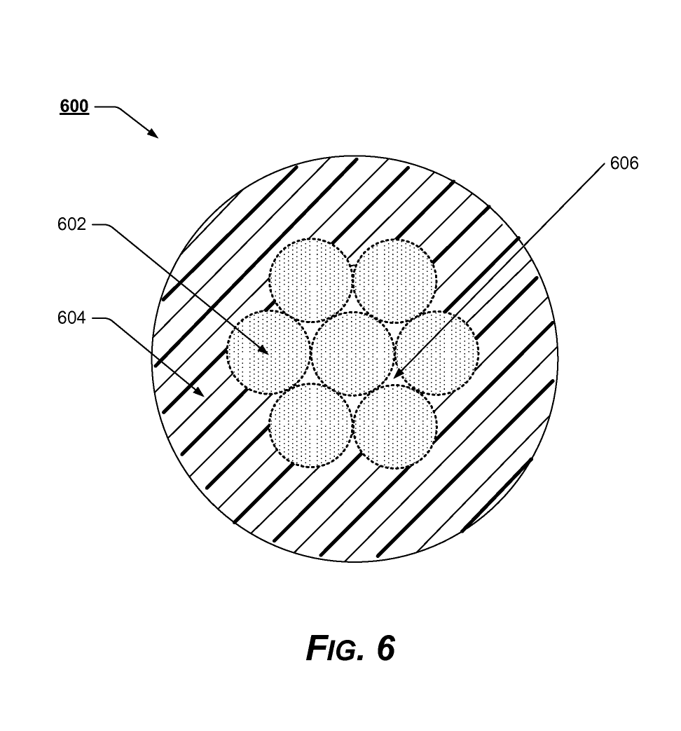

FIG. 6 shows example composition of a coated synthetic yarn 600 for use in an example cable 700 for harsh environments. The example coated synthetic yarn 600 has yarn fibers or strands 602 that are coated or encased in soft polymer 604. Air pockets 606 of various sizes present in and between the synthetic yarn strands 602 compress to compensate for thermal expansion of other components in the example cable 700.

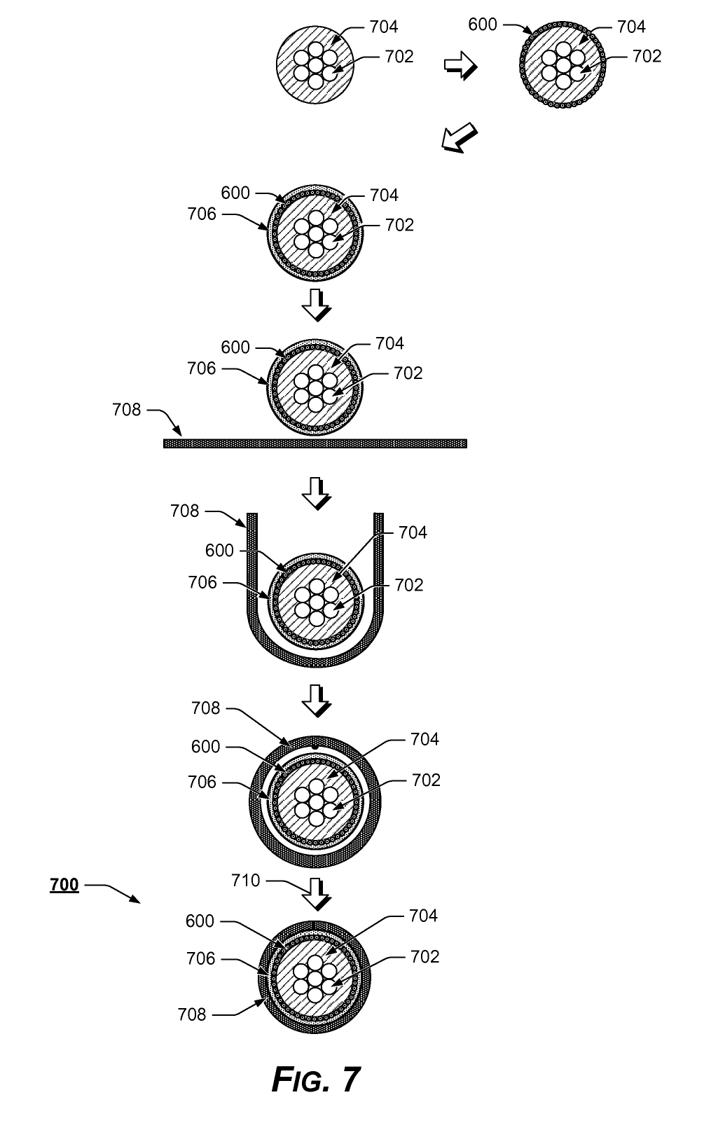

FIG. 7 shows an example manufacturing process for making the example cable 700 including coated synthetic yarn 600 in which the yarn stranding 602 itself is coated or encased in soft polymer 604. The example cable 700 has a stranded or solid metallic conductor 702 that is encased in a suitable hard polymer insulation 704. The coated synthetic yarn 600 is cabled over the hard-polymer-insulation layer 704, which in turn embeds the metallic conductors 702. The coated synthetic yarn 600 may be made of glass, KEVLAR, Polyamide, polyester, acrylic, polytetrafluoroethylene (PTFE), or other synthetic fibers, coated in soft polymer 604 Immediately after the coated synthetic yarn 600 is applied, the soft polymer 604 coating of the yarn 600 may be melted to form a continuous jacket extending radially from the hard polymer insulation layer 704 of the example cable 700 toward the outside periphery where the metal jacket 708 will be placed, eliminating the need for another separate extrusion of soft polymer 604 to be applied over the served layer 600.

The coated synthetic yarn 600 minimizes the amount of air in the system and also avoids a through-path for gases to travel in spaces that may not get filled within the cable. A metallic sheet 708 is then rolled and seam-welded to become the metallic tube 708 over the melted soft polymer extruded yarn 600 and then the metallic tube 708 is drawn down to fit tightly over the soft polymer-coated synthetic yarn 600. The air 606 in the coated synthetic yarn 600 can compress to compensate for the pressure induced by different thermal expansions of the different components of the example cable 700. In an implementation, another explicit layer of soft polymer 706 may be applied over the soft polymer 604 that embeds the yarn stranding 602.

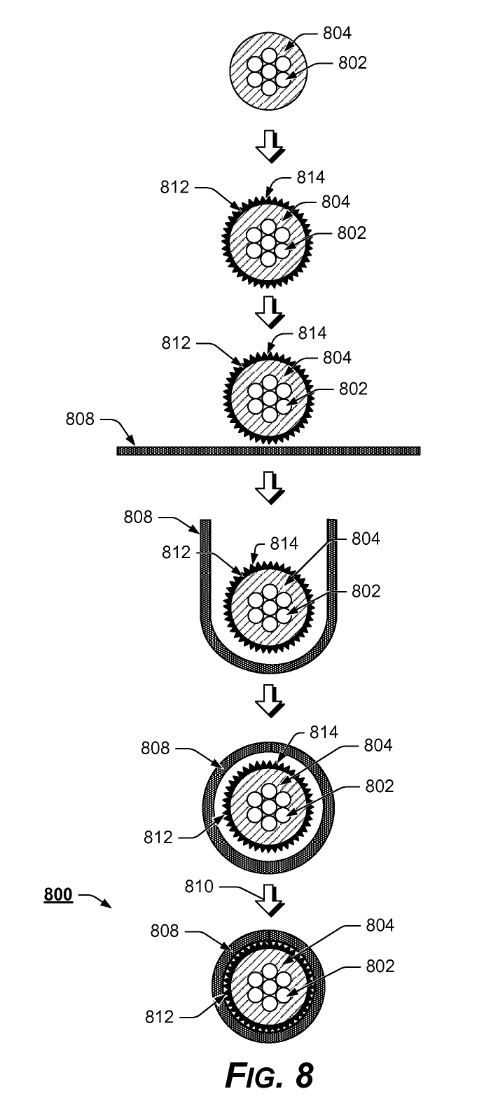

FIG. 8 shows an example cable 800 similar to that of FIG. 4, except that the example cable 800 omits the soft polymer layer 404 over the serrated hard polymer layer 812. In the event of excessive thermal expansion in the downhole environment, this serrated surface 812 expands into the interstitial air spaces 814 between the serrated polymer 812 and the outer metallic tube 808.

FIG. 8 also depicts an example manufacturing process for the example cable 800 that has the serrated hard polymer layer 812 directly against the metal tubing 808. A layer of hard polymer 804 is extruded over a solid or stranded metallic conductor 802 to provide electrical insulation and physical protection. A second layer of hard polymer 812 with a serrated outer surface 814 is extruded over the first hard polymer layer 804. The material for the second, serrated polymer layer 812 may be the same as for the first insulation polymer layer 804 and can be a single continuous matrix extruded, for example, in one step over the metallic conductor 802. The second, serrated polymer 812 may be amended to allow swelling to take place when the serrated polymer 812 encounters oil, water, methane gas or harsh chemicals, such as hydrogen sulfide or carbon dioxide. These chemicals swell the polymer 812 allowing the swelling to seal off space left for thermal expansion between the serrated polymer 812 and outer metal cladding 808. A strip of suitable metal is used to create a metallic tube 808 over the conductor 802. The metallic strip 808 is passed through a series of shaping dies as needed to create a metal tube 808 over the conductor 802. During formation, edges are seam-welded to complete the metal tube 808. The metallic tube 808 is drawn down tightly over the serrated hard polymer 812 of the conductor layers to allow for interstitial air spaces 814 left between the serrated polymer 812 and the outer metallic tube 808 to remain so that the polymer 812 can expand into these spaces 814 in case there is excessive thermal expansion of the polymer 812 compared to the metallic tube 808 when other expansion relief measures, such as the helical configuration, are not sufficient to compensate for thermal expansion.

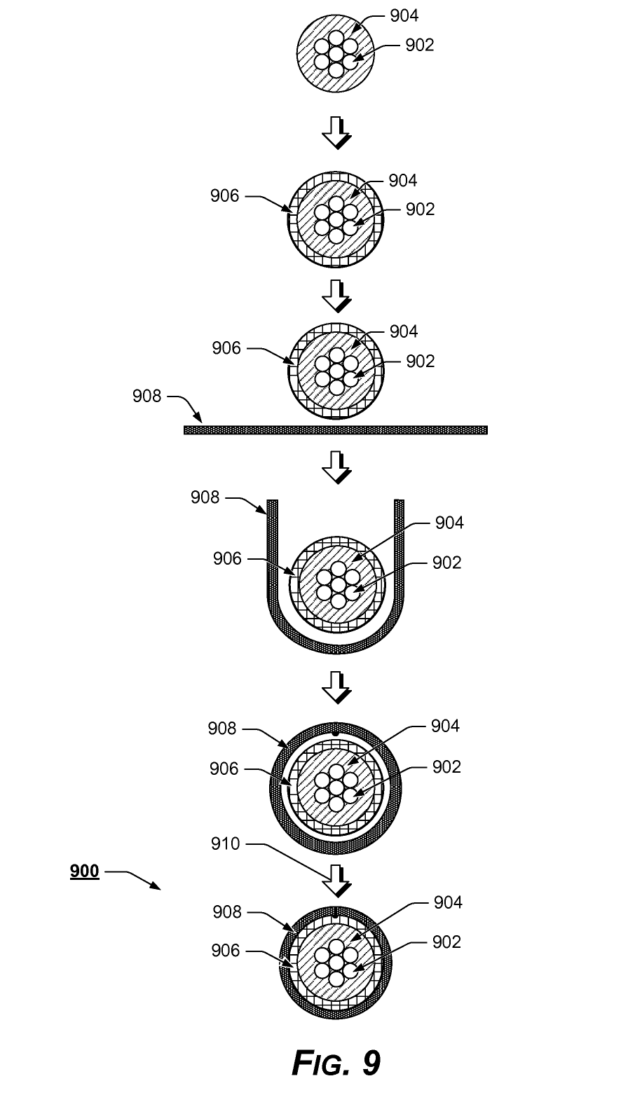

FIG. 9 shows an example cable 900 that uses a closed-cell foamed polymer layer 912 to cushion the conductor 902 and hard insulation 904 against the outer metallic tube 908. In the event of thermal expansion in the downhole environment, the air or gas in the closed cell foamed polymer 912 compresses rather than allowing the increased pressure to cause damage to the conductor components. The example cable 900 has no air gap between the metallic tube 908 and the foamed polymer 912, unlike the above serrated design of FIG. 8, which may potentially allow the air gaps to become a conduit for mobile harmful chemicals to move upward if there is a breach in the metal cladding 908.

FIG. 9 also depicts an example manufacturing process for creating the example cable 900 that incorporates the closed-cell foamed polymer layer 912 for cushioning. The layer of hard polymer 904 is extruded over a solid or stranded metallic conductor 902 to provide electrical insulation and physical protection. The layer of closed-cell foamed polymer 912 is extruded over the hard polymer layer 904.

In an implementation, the foamed polymer 912 may the same material as the insulation 904 and may be bonded together into one single matrix. The single matrix of insulation 904 and the foamed polymer 912 may be extruded at the same time on to the conductors 902 to facilitate better bonding between the two layers. A strip of suitable metal is used to create the metallic tube 908 over the conductor interior. Thus a metallic strip 908 may be passed through a series of shaping dies as needed to create the metal tube 908 over the conductor 902 and interior layers. When the metal tube 908 is formed, the edges are seam-welded to complete the metal tube 908. The metallic tube 908 is then drawn down to fit tightly over the conductor's closed-cell foamed polymer layer 912. The closed-cell foamed polymer 912 conforms against the inside of the metallic tube 908 to fill any interstitial spaces.

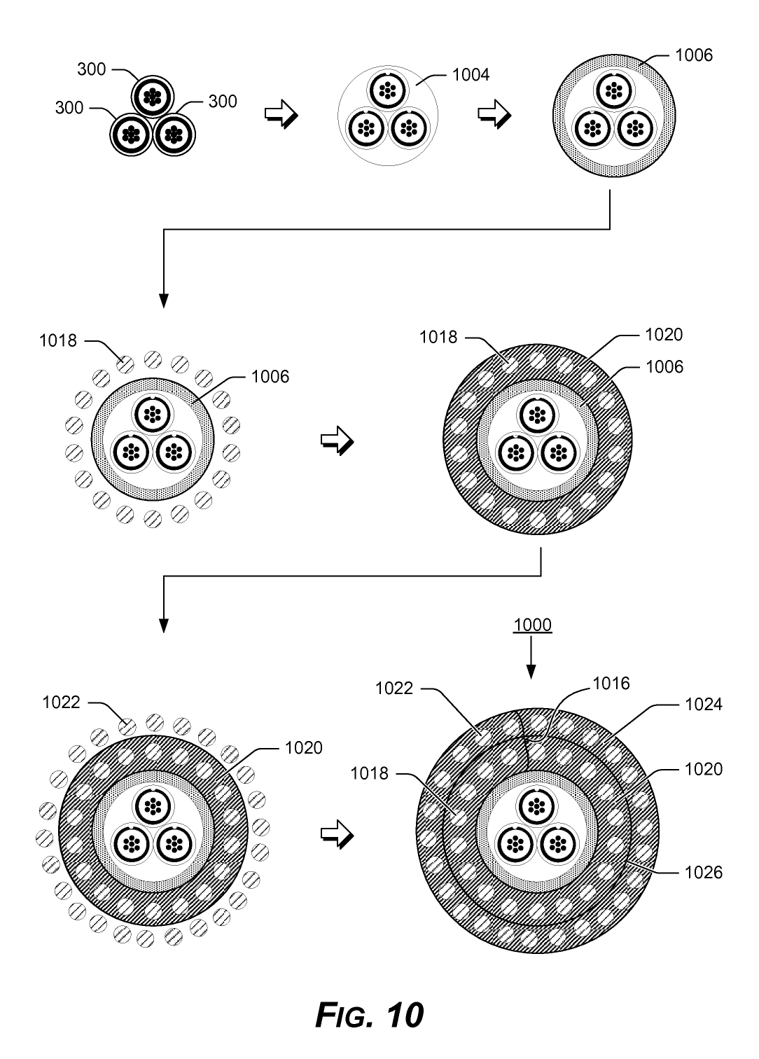

FIG. 10 shows an example cable 1000 in which an exterior smooth jacket 1016 surrounds a cable interior that incorporates features of the cables shown in FIGS. 2-9. The outer jacketing system 1016 includes chemically resistant hard polymers 1020 & 1024 and metallic strength members 1018 & 1022. The outer jacket system 1016 is bonded to the polymer 1020 distributed in the interstices of a first armor layer 1018 and second outer armor layer 1022 through the spaces between the outer armor 1022 to impart high strip-resistance and tear-resistance to the outer jacket system 1016 and to prevent migration of fluids between the interfaces of armors 1018 & 1022 and intervening polymeric material 1020.

FIG. 10 also depicts an example manufacturing process for creating the example cable 1000 that includes the outer jacketing system 1016 and the features from cables shown in FIGS. 2-9. A number of insulated conductors armored in metallic tubes, as described in FIGS. 2-9, are cabled together. For example, the metallic clad conductors may each be an instance of example cable 300. A soft polymer 1004, such as a fluoropolymer FEP, TEFZEL, PFA or polyvinylidene fluoride (PVDF) that is resistant to harsh chemicals such as hydrogen sulfide and carbon dioxide is extruded over the example cables 300 to fill all interstitial spaces between each cable 300 and give the bundled cable core a circular profile. Polymers such as ethylene-propylene diene monomer (EPDM) may also be used in place of fluoropolymer and may be amended to allow swelling in order to provide sealing against each cable 300 when the polymer 1004 encounters oil, water, methane gas, or harsh chemicals such as hydrogen sulfide and carbon dioxide. Then, a layer of jacketing polymer 1006, such as PEEK or a fluoropolymer like FEP, TEFZEL, PFA or polyvinylidene fluoride (PVDF) is extruded over the soft filler polymer 1004 to complete the cable core.

A number of strength members 1018 in an inner layer of the outer jacket system 1016 are cabled over the cable core. The inner layer of strength members 1018 is embedded partially into the cable core's outer jacket 1006 filling all interstitial spaces between the inner strength members 1018 and the core jacket 1006. Additional jacketing polymer 1020 is added over the top of the first armor 1018 filling all interstitial spaces outside the first armors 1018 and facilitating embedment of the second, outer armor layer 1022.

The second, outer layer of strength members 1022 is cabled together over the jacketed inner strength member layer 1018. The outer armor strength members 1022 are embedded partially into the underlying polymer jacket 1020 on the outside of the inner armors 1018 facilitating the filling of all interstitial spaces between the polymer jacket 1020 on the outside of the inner armor 1018 and the outer armors 1022.

The composition of the metallic strength members 1018 & 1022 can be selected based on ability to withstand exposure to harsh downhole chemicals at high temperatures and pressures. For example, the metallic strength members 1018 & 1022 may be made of alloys such as HC265, MP335, 27-7MO or other suitable alloys (H.C. Starck Inc., Euclid, Ohio). Steel, clad in a chemically resistant plating (nickel, molybdenum or other suitable combination of alloy material), may also be used.

An outermost jacket 1024 is extruded over the embedded outer armors 1022 and facilitates bonding of the outer jacket 1024 to the jacket material 1020 between the inner armors 1018 and the outer armors 1022. The outer jacket 1024 is bonded to the polymer 1020 that is already distributed in the interstices of the first armor layer 1018 and the second armor layer 1022 through the spaces between the outer armor 1022 to impart high strip resistance and tear resistance to the outer jacket system 1016. The interface line 1026 shown in FIG. 10 between polymer layer 1020 and polymer layer 1024 may represent a layer of coalescence, melting together, or other type of bonding or melding of polymer layers 1020 and 1024 into each other and into a single polymer layer or component.

The jacketing polymer can be a hard polymer extruded over and between the layers of the armor wire strength members 1018 & 1022. The multiple layers 1020 & 1024 of the jacketing polymer may bond together to form a continuous matrix around the armor wires 1018 & 1022. The layers 1018 & 1022 of jacketing polymer may be the same material or may be otherwise bondable to each other. Optionally, one or more layers of the jacketing polymer may be amended with short fibers to provide additional strength and abrasion resistance.

The inner armor layer 1018 does not touch the outer armor layer 1022. The inner armor 1018 and outer armor 1022 are separated by a solid polymer jacketing layer 1020 that prevents fluids from getting to the inner armor layer 1018. This allows sealing off fluid from the inner armor layers 1018 even if there is damage to the outer jacket 1022 & 1024 causing fluids to enter the outer armor layer 1022.

Each outer armor strength member 1022 does not touch adjacent outer armor strength members 1022. There is a polymeric layer 1024 separating the individual outer armor strength members 1022 from each other. This prevents fluids from migrating along all the outer armor strength members 1022 if there is localized damage to the outer jacket 1022 at any point along the example cable 1000.

The features of the inner armor 1018 not touching the outer armor layer 1022 and the outer armor strength members 1022 each being separated from each other by polymer 1024 also allows efficient sealing of the example cable 1000 at the bottom termination and upper termination of the example cable 1000.

Example Method

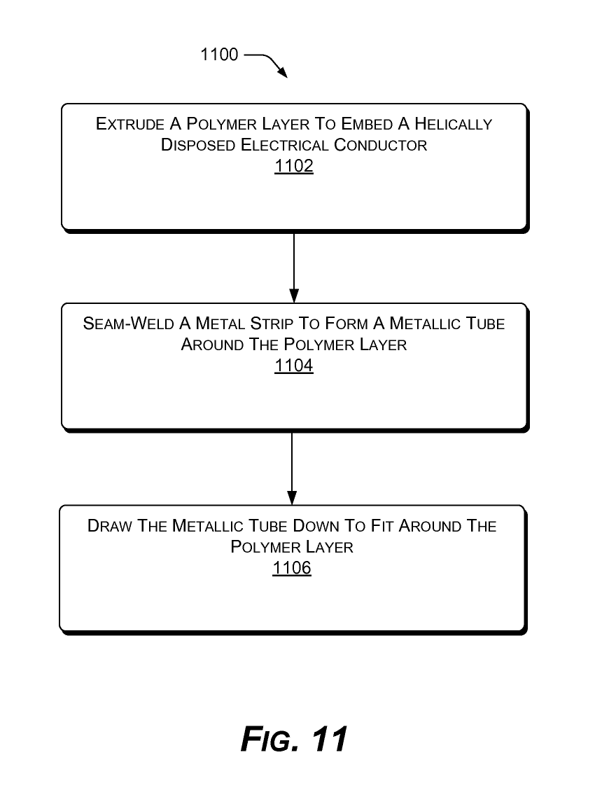

FIG. 11 is a flow diagram of an example method 1100 of constructing an electric submersible pump cable for harsh environments. In the flow diagram the individual operations are shown as blocks.

At block 1102, a polymer layer is extruded to embed a helically disposed electrical conductor.

At block 1104, a metal strip is seam-welded to form a metallic tube around the polymer layer.

At block 1106, the metallic tube is drawn down to fit tightly around the polymer layer.

Conclusion

Although only a few example embodiments have been described in detail above, those skilled in the art will readily appreciate that many modifications are possible in the example embodiments without materially departing from the subject matter. Accordingly, all such modifications are intended to be included within the scope of this disclosure as defined in the following claims. In the claims, means-plus-function clauses are intended to cover the structures described herein as performing the recited function and not only structural equivalents, but also equivalent structures. It is the express intention of the applicant not to invoke 35 U.S.C. §112, paragraph 6 for any limitations of any of the claims herein, except for those in which the claim expressly uses the words ‘means for’ together with an associated function.

1. A cable for supplying power to an electric submersible pump (ESP), comprising:
a helically disposed electrical conductor;
a hard polymer layer embedding the helically disposed electrical conductor; and
a seam-welded metallic tube drawn over the hard polymer layer.

2. The cable of claim 1, wherein the hard polymer layer is resistant to hydrogen sulfide and carbon dioxide at a high downhole pressure and a high downhole temperature.

3. The cable of claim 1, wherein the hard polymer layer comprises one of a crystallized PEEK poly(ether ether ketone), an insulation grade ethylene-propylene diene monomer (EPDM), a polypropylene polymer, a perfluoroalkoxy (PFA) fluoropolymer, or a fluorinated ethylene propylene (FEP) polymer.

4. The cable of claim 1, wherein the seam-welded metallic tube comprises one of an inconel material, a HC265 material, a MP335 material, a 27-7MO material, an alloy resistant to hydrogen sulfide and carbon dioxide at high temperature and high pressure, or a steel material clad in a chemically-resistant plating of nickel, molybdenum or an alloy material.

5. The cable of claim 1, wherein a helical disposition of the cable varies in a degree of twist to absorb an expansion and a contraction of different cable components with different coefficients of thermal expansion.

6. The cable of claim 1, further comprising a soft polymer layer between the hard polymer layer and the seam-welded metallic tube to absorb changes in volume when the helically disposed electrical conductor, the hard polymer layer, and the seam-welded metallic tube thermally expand and contract with different coefficients of thermal expansion.

7. The cable of claim 6, wherein the soft polymer layer comprises one of an ethylene-propylene diene monomer (EPDM), a perfluoroalkoxy (PFA) fluoropolymer, a fluorinated ethylene propylene (FEP) polymer, a TEFZEL material, a modified ETFE (ethylene-tetrafluoroethylene) fluoroplastic, or a polyvinylidene fluoride (PVDF).

8. The cable of claim 6, further comprising a serrated hard polymer layer between the hard polymer layer and the soft polymer layer to secure the soft polymer layer to the hard polymer layer.

9. The cable of claim 6, further comprising a yarn layer between the hard polymer layer and the soft polymer layer to compensate for thermal expansion of a cable component, wherein the yard layer comprises one of a glass, a KEVLAR material, a polyamide material, a polyester material, an acrylic material, a polytetrafluoroethylene (PTFE) material, or a synthetic fiber.

10. The cable of claim 9, wherein yarn fibers of the yard layer are encased in a soft polymer.

11. The cable of claim 1, wherein the hard polymer layer has a serrated surface to provide air spaces for thermal expansion between the hard polymer layer and the seam-welded metallic tube.

12. The cable of claim 1, further comprising a closed-cell foamed polymer layer between the hard polymer layer and the seam-welded metallic tube to cushion the hard polymer layer against the seam-welded metallic tube.

13. The cable of claim 1, further comprising an outer jacket around one or more instances of the cable, the outer jacket comprising one or more layers of metallic strength members embedded in one or more layers of a smooth polymer.

14. The cable of claim 13, wherein the strength members comprise one of a HC265 material, a MP335 material, or a steel material clad in a chemically resistant plating of one of nickel, molybdenum, or chemical resistant alloy.

15. The cable of claim 13, wherein the strength members in the outer jacket are separated from each other by the hard polymer to enable a seal at a bottom termination or a top termination of the cable and outer jacket.

16. An apparatus, comprising:
an electrical cable resistant to corrosive chemicals at a high pressure and a high temperature;
an electrical conductor in the electrical cable;
a chemically resistant polymer layer embedding the electrical conductor; and
a seam-welded metallic tube drawn over the chemically resistant polymer layer.

17. The apparatus of claim 16, wherein at least one of the electrical conductor, the chemically resistant polymer layer, and the seam-welded metallic tube are helically disposed to compensate for differential thermal expansion within the electrical cable.

18. The apparatus of claim 16, further comprising a cushion layer between the seam-welded metallic tube and a core of the cable.

19. A method, comprising:
extruding a polymer layer around a helically disposed electrical conductor;
seam-welding a metal strip to form a metallic tube around the polymer layer; and
drawing the metallic tube down to fit tightly around the polymer layer.

20. The method of claim 19, further comprising encasing the polymer layer in a cushion layer.
